(19) United States
(12) Patent Application Publication
(10) Pub. No.: US 2006/0044222 A1
(43) Pub. Date: Mar. 2, 2006

(54) Plasma display device and driving method thereof

(76) Inventors: Jin-Ho Yang, Suwon-si (KR); Jin-Sung Kim, Suwon-si (KR); Seung-Hun Chae, Suwon-si (KR)

Correspondence Address: CHRISTIE, PARKER & HALE, LLP, PO BOX 7068, PASADENA, CA, 91109-7068, US

(21) Appl. No.: 11/192,530

(22) Filed: Jul. 29, 2005

(30) Foreign Application Priority Data
Sep. 1, 2004 (KR) 10-2004-0069493

(51) Int. Cl. G09G 3/28

(52) U.S. Cl. 345/60

(57) ABSTRACT

Disclosed is a plasma display device and driving method thereof. The plasma display device uses a single switch to increase and decrease voltages in a power recovery circuit. Accordingly, the number of switches is reduced, and a circuit and control signals are reduced by eliminating a switch, thereby reducing product costs.

### CROSS-REFERENCE TO RELATED APPLICATION

This application claims priority to and the benefit of Korean Patent Application No. 10-2004-0069493 filed in the Korean Intellectual Property Office on Sep. 1, 2004, the entire content of which is incorporated herein by reference.

### BACKGROUND OF THE INVENTION

1. Field of the Invention

The present invention relates to a plasma display device and driving method thereof.

2. Description of the Related Art

Plasma display panels are flat panel displays that use plasma generated by gas discharge to display characters or images. Depending on their sizes, plasma display panels can have tens to millions of pixels arranged in the form of a matrix. These plasma display panels can be classified into a direct current (DC) type or an alternating current (AC) type depending on patterns of waveforms of driving voltages applied thereto and discharge cell structures thereof.

An AC plasma display panel has scan electrodes and sustain electrodes in parallel on one side thereof, and has address electrodes crossing the scan electrodes and sustain electrodes on another side thereof. The sustain electrodes are formed to correspond to the respective scan electrodes, with one terminal of each of the sustain electrodes being coupled in common to respective terminals of the scan electrodes. In general, a method for driving the AC plasma display panel includes a plurality of temporal operation periods, i.e., a reset period, an address period, and a sustain period.

The reset period is a period to reset a state of each cell such that an addressing operation of each cell is smoothly performed, and the address period is a period to apply an address voltage to a cell (or an addressed cell) to accumulate wall charges on the addressed cell to thereby select a cell to be turned on and a cell not to be turned on in the PDP. The sustain period is a period to apply sustain discharge voltage pulses to the addressed cell to thereby perform a discharge according to how a picture is to be actually displayed. Since a discharge space between a scan electrode and a sustain electrode, and a discharge space between a surface on which an address electrode is formed and a surface on which the scan and sustain electrodes are formed can operate as capacitive loads (referred to as panel capacitors hereinafter), a certain capacitance exists on the panel. Therefore, in order to apply waveforms for a sustain discharge, charge-injecting of a reactive power for generating a predetermined voltage to the capacitance is needed in addition to injecting a power for a sustain discharge. Hence, a sustain discharge circuit includes a power recovery circuit for recovering the reactive power and re-using the same, as shown in the power recovery circuit by L. F. Weber in U.S. Pat. Nos. 4,866,349 and 5,081,400. As shown in U.S. Pat. Nos. 4,866,349 and 5,081,400, the conventional power recovery circuit has two switches having one terminal coupled to a power-recovery power source, the two switches being coupled in series with each other and forming a resonance. However, the switches for forming the resonance are realized by coupling a plurality of transistors in parallel in order to withstand a large resonance current, so usage of the conventional power recovery circuit increases product costs. The information disclosed in this Background of the Invention section is only for enhancement of understanding of the background of the invention, and therefore, unless explicitly described to the contrary, it should not be taken as an acknowledgment or any form of suggestion that this information forms the prior art that is already known in this country to a person of ordinary skill in the art.

### SUMMARY OF THE INVENTION

An embodiment of the present invention provides a plasma display panel driver including a power recovery circuit for minimizing the number of driving elements, and a driving method thereof.

In an embodiment of the present invention, a plasma display device includes a panel and a driving circuit. The panel includes a plurality of first electrodes and a plurality of second electrodes, and the driving circuit outputs a signal for driving at least one of the first electrodes. The driving circuit includes a first switch, a second switch, an inductor, a third power source, a third switch, a first diode, a second diode, a third diode, and a fourth diode. The first switch is coupled between the at least one first electrode and a first power source for supplying a first voltage to the at least one first electrode in a sustain period. The second switch is coupled between the at least one first electrode and a second power source for supplying a second voltage lower than the first voltage to the at least one first electrode in the sustain period. The inductor has a first terminal coupled to the at least one first electrode. The third power source supplies a resonance voltage. The first diode has an anode coupled to the third power source and a cathode coupled to a first terminal of the third switch. The second diode has an anode coupled to a second terminal of the third switch and a cathode coupled to a second terminal of the inductor. The third diode has a cathode coupled to the first terminal of the third switch and an anode coupled to the second terminal of the inductor. The fourth diode has a cathode coupled to the third power source and an anode coupled to the second terminal of the third switch.

In one embodiment, the driving circuit turns on the third switch in the sustain period and uses a resonance of the inductor and the at least one first electrode through a current path in an order of the third power source, the first diode, the third switch, the second diode, the inductor, and the first electrode to increase the voltage at the first electrode to be the first voltage. In one embodiment, the driving circuit turns on the third switch in the sustain period and uses a resonance of the inductor and the at least one first electrode through a current path in an order of the first electrode, the inductor, the third diode, the third switch, the fourth diode, and the third power source to decrease the voltage at the first electrode to be the second voltage.

In another embodiment of the present invention, a method for driving a plasma display device for alternately applying a first voltage and a second voltage to a panel capacitor formed between a first electrode and a second electrode through a driving circuit including a switch and an inductor forming a resonance circuit is provided. In the method, a) a first resonance is generated between the panel capacitor and the inductor through a first path formed through the switch, and a voltage at a first electrode of the panel capacitor is charged to be the first voltage; b) the voltage at the first electrode of the panel capacitor is maintained at the first voltage; c) a second resonance is generated between the panel capacitor and the inductor through a second path formed through the switch, and the voltage at the first electrode of the panel capacitor is discharged to be the second voltage, the second path being different from the first path; and d) the voltage at the first electrode of the panel capacitor is maintained at the second voltage.

### BRIEF DESCRIPTION OF THE DRAWINGS

FIG. 1 shows a plasma display device according to an embodiment of the present invention.

FIG. 2 shows a circuit diagram of a Y electrode driver according to an embodiment of the present invention.

FIG. 3 shows a waveform diagram of a Y electrode voltage of a sustain driver, a current of an inductor, and a timing diagram of a switch according to an embodiment of the present invention.

FIG. 4A, FIG. 4B, FIG. 4C, and FIG. 4D show current paths of a sustain driver in respective modes according to an embodiment of the present invention.

### DETAILED DESCRIPTION

In the following detailed description, exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. There may be parts shown in the drawings, or parts not shown in the drawings, that are not discussed in the specification, as they are not essential to a complete understanding of the invention. Like reference numerals designate like elements.

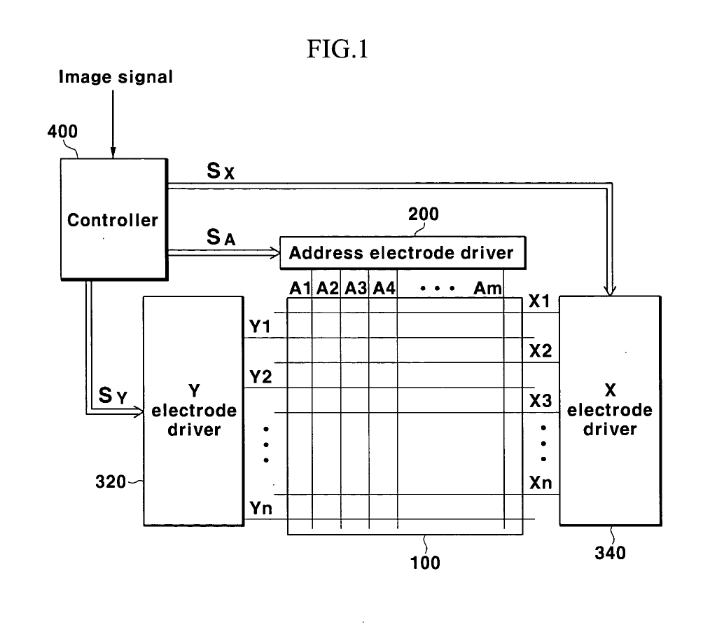

A plasma display panel according to an embodiment of the present invention, and a driver and a driving method thereof, will be described with reference to drawings. A configuration of a plasma display device according to an embodiment of the present invention will be described with reference to FIG. 1.

FIG. 1 shows a plasma display device according to an embodiment of the present invention.

As shown in FIG. 1, the plasma display device includes a plasma display panel 100, an address driver 200, a Y electrode driver (e.g., one of a scan electrode driver and a sustain electrode driver) 320, an X electrode driver (e.g., another one of the scan electrode driver and the sustain electrode driver) 340, and a controller 400.

The plasma display panel 100 includes a plurality of address electrodes A1 to Am in a column direction, and first electrodes (e.g., Y electrodes) Y1 to Yn and second electrodes (e.g., X electrodes) X1 to Xn in a row direction. The address driver 200 receives an address driving control signal (SA) from the controller 400, and applies a display data signal for selecting a discharge cell to be displayed to the address electrodes. The Y electrode driver 320 and the X electrode driver 340 respectively receive a Y electrode driving signal (SY) and an X electrode driving signal (SX) from the controller 400, and respectively apply the same to the X electrodes and the Y electrodes. The controller 400 receives an external image signal, generates an address driving control signal (SA), a Y electrode driving signal (SY) and an X electrode driving signal (SX), and transmits the same to the address driver 200, the Y electrode driver 320, and the X electrode driver 340, respectively.

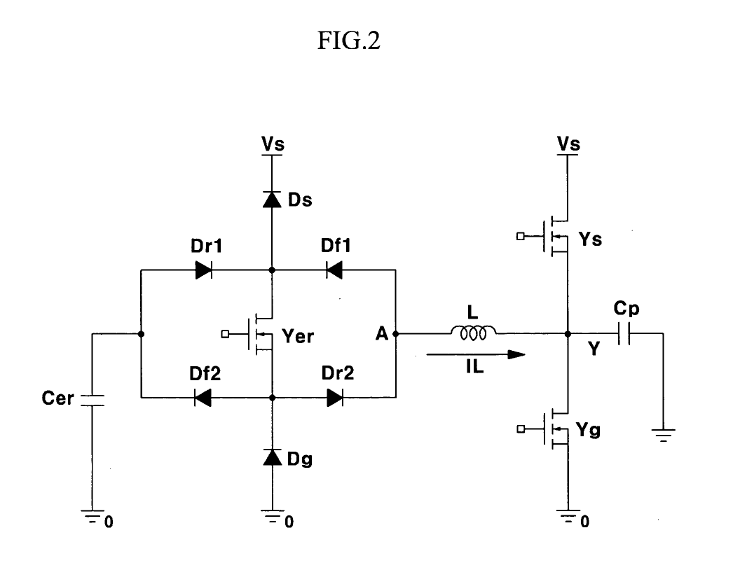

A configuration of a Y electrode driver (e.g., the Y electrode driver 320) will be described with reference to FIG. 2. FIG. 2 shows a configuration of a sustain driving circuit of the Y electrode driver according to an embodiment of the present invention.

As shown in FIG. 2, the Y electrode driver for supplying a voltage of Vs for a sustain discharge to at least one Y electrode in a sustain period includes a switch Ys coupled to a power source Vs and supplying the voltage of Vs (or the voltage of the power source Vs), and a switch Yg coupled to a ground and supplying a ground voltage (e.g., 0V).

The Y electrode driver further includes a switch Yer coupled between the power source Vs and the ground, a power recovery capacitor Cer, and an inductor L used for power recovery in the sustain period. The capacitor Cer and the switch Yer are coupled through a diode Dr1 and a diode Df2, and the switch Yer and the inductor L are coupled through a diode Df1 and a diode Dr2. In other words, cathodes of the diode Dr1 and the diode Df1 are coupled to a drain of the switch Yer, and anodes of the diode Df2 and the diode Dr2 are coupled to a source of the switch Yer. N-type (or NMOS) transistors are used as the switches Ys, Yg, and Yer in the above-described embodiment, but other transistors are also applicable (e.g., PMOS transistors).

Further, the sustain driver may include a diode Ds coupled between the power source Vs and the switch Yer for performing a clamp operation so that a drain voltage at the switch Yer may not be increased to be higher than the voltage of Vs, and a diode Dg coupled between the switch Yer and the ground for performing a clamp operation so that a source voltage at the switch Yer may not be decreased to be less than 0V because of an undershoot.

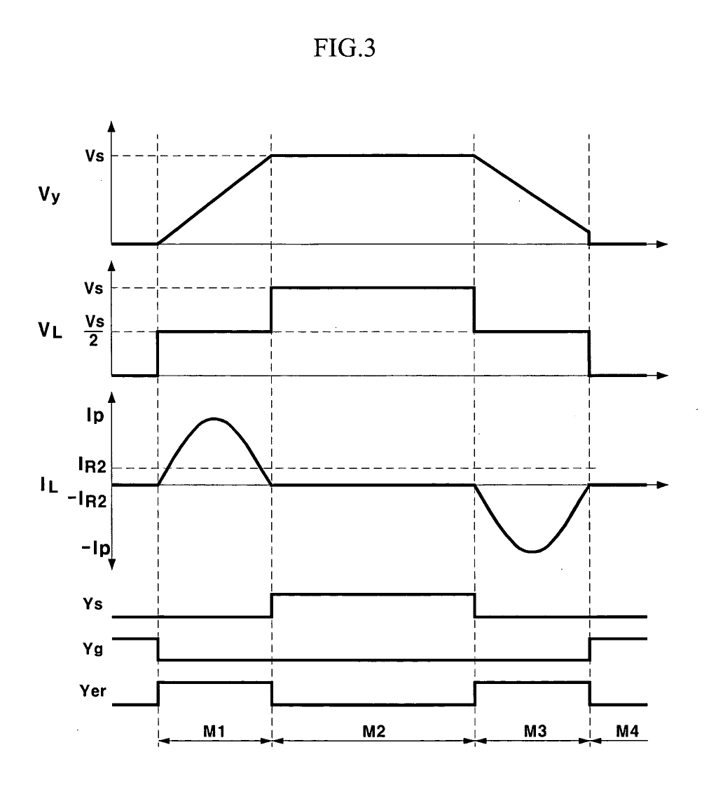

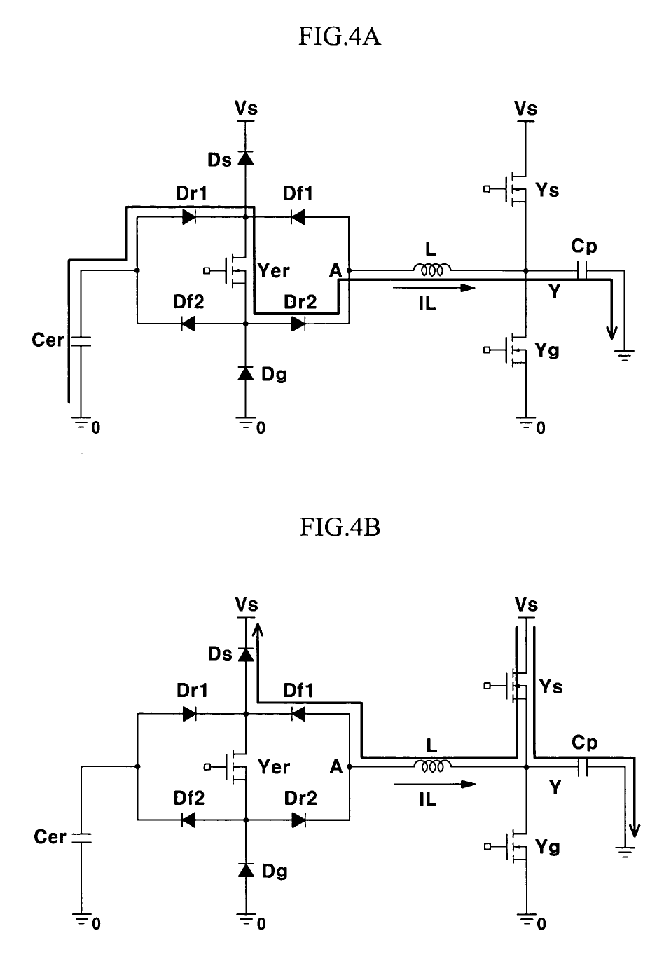

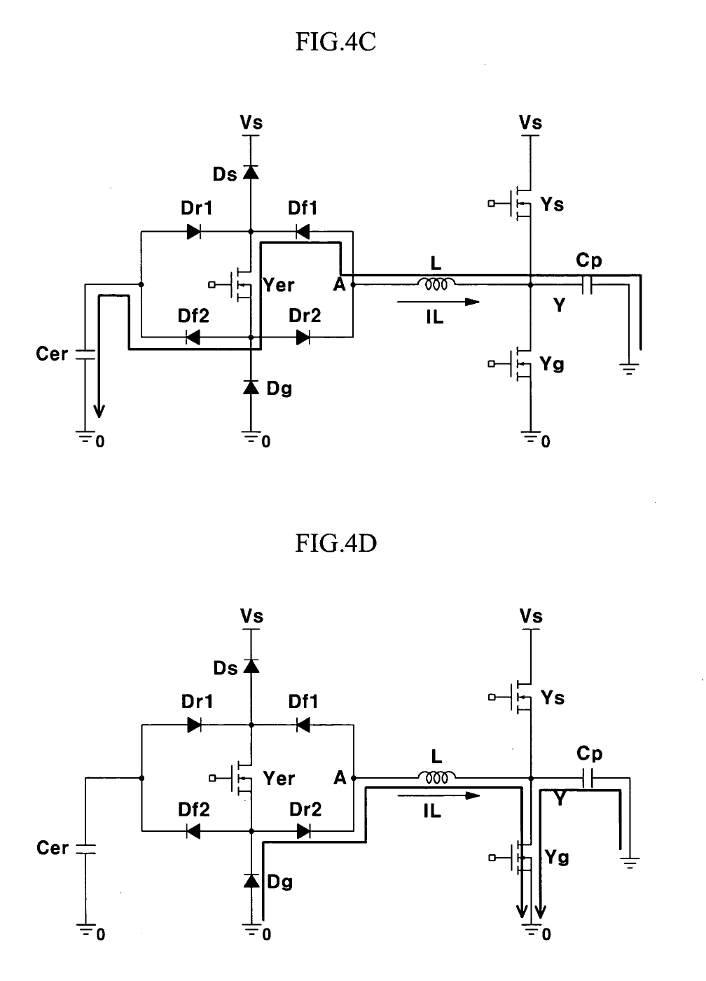

A time-variant operation of the Y electrode driver of FIG. 2 in a sustain period will be described with reference to FIG. 3 and FIGS. 4A to 4D. The operation has four modes M1 to M4 which are changed by an operation of switches. A phenomenon referred to as a resonance does not indicate continuous oscillation, but represents a change of voltage and current caused by a combination of the inductor L and a panel capacitor Cp when the switch Yer is turned on. Also, the panel capacitor Cp equivalently represents capacitance between an X electrode and the Y electrode, and the X electrode of the panel capacitor Cp is shown to be coupled to the ground for ease of description, but the X electrode is actually coupled to an X electrode driver (e.g., the X electrode driver 340). An operation of the Y electrode driver (e.g., the Y electrode driver 320) will now be described for exemplary purposes. In addition, since the X electrode driver (e.g., the X electrode driver 340) is operated in substantially the same manner as the Y electrode driver (e.g., the Y electrode driver 320), an operation of the X electrode driver will not be described in more detail.

FIG. 3 shows a waveform diagram of a Y electrode voltage of the Y electrode driver, a current of the inductor, and a timing diagram of the switches Ys, Yg, and Yer. FIG. 4A to FIG. 4D show current paths of the Y electrode (or sustain) driver in respective modes. It is assumed that the capacitor Cer is charged with a voltage of V (V=Vs/2) before Mode 1 (M1) starts.

\textcircled{1} Mode 1 (M1)—Refer to FIG. 4A.

When the switch Yer is turned on, a current path is formed in the order of the capacitor Cer, the diode Dr1, the switch Yer, the diode Dr2, the inductor L, and the panel capacitor Cp. The voltage at a node A becomes the voltage of Vs/2, and a resonance occurs between the inductor L and the panel capacitor Cp. The panel capacitor Cp is charged by the resonance, and the Y electrode voltage of Vy of the panel capacitor Cp is gradually increased from 0V to Vs as shown in FIG. 3. That is, the panel capacitor Cp is charged. Also, the current of I_{L} flowing to the inductor L is increased and decreased in a sine waveform.

\textcircled{2} Mode 2 (M2)—Refer to FIG. 4B.

The switch Yer is turned off and the switch Ys is turned on when the Y electrode voltage of Vy is increased to be the predetermined voltage Vs, or the current of I_{L} flowing to the inductor L is decreased to be lower than 0A. Therefore, the Y electrode voltage of Vy of the panel capacitor Cp is maintained at the voltage of Vs through a current path in the order of the switch Ys and the panel capacitor Cp.

\textcircled{3} Mode 3 (M3)—Refer to FIG. 4C.

When the switch Ys is turned off and the switch Yer is turned on, a current path is formed in the order of the panel capacitor Cp, the inductor L, the diode Df1, the switch Yer, the diode Df2, and the capacitor Cer, and a resonance occurs between the inductor L and the panel capacitor Cp. The Y electrode voltage of Vy of the panel capacitor Cp is gradually decreased to 0V by the resonance. That is, the panel capacitor Cp is discharged. Also, the current of I_{L} flowing to the inductor L is decreased and increased in the sine waveform as shown in FIG. 3.

\textcircled{4} Mode 4 (M4)—Refer to FIG. 4D

The switch Yer is turned off and the switch Yg is turned on when the Y electrode voltage of Vy is decreased to a predetermined voltage or the current of I_{L} flowing to the inductor L is increased to 0A. Accordingly, the Y electrode voltage of Vy of the panel capacitor Cp is maintained at 0V. The operations of Modes 1 to 4 are then repeated by the X electrode driver when Mode 4 is terminated.

Accordingly, the number of switches in a power recovery circuit according to an embodiment of the present invention is reduced since a power recovery operation is performed by a single switch. That is, referring to FIGS. 3, 4A, 4B, 4C, and 4D, the residual current in the inductor L after Mode 1 is recovered through the path in the order of the switch Ys, the inductor L, the diode Df1, the clamping diode Ds, and the power source Vs; and the residual current in the inductor L after Mode 3 is recovered through the path in the order of the ground (e.g., 0V), the clamping diode Dg, the diode Dr2, the inductor L, and the switch Yg. Therefore, the resonance of an inductor, a diode, and a parasitic capacitor of a single switch (e.g., the switch Yer) prevents a drain voltage at the switch (e.g., the switch Yer) from increasing to be higher than a voltage of Vs or decreasing to be less than 0V.

As such, voltages can be increased or decreased by using a single switch in a power recovery circuit according to the present invention. Hence, an additional switch is eliminated and a circuit and control signals for driving the switch and/or the circuit are reduced to reduce a product cost.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A plasma display device comprising:
a panel including a plurality of first electrodes and a plurality of second electrodes; and
a driving circuit for outputting a signal for driving at least one of the first electrodes,
wherein the driving circuit comprises:
a first switch coupled between the at least one of the first electrodes and a first power source for supplying a first voltage to the at least one of the first electrodes in a sustain period;
a second switch coupled between the at least one of the first electrodes and a second power source for supplying a second voltage lower than the first voltage to the at least one of the first electrodes in the sustain period;
an inductor having a first terminal coupled to the at least one of the first electrodes;
a third power source for supplying a resonance voltage;
a third switch;
a first diode having an anode coupled to the third power source and a cathode coupled to a first terminal of the third switch;
a second diode having an anode coupled to a second terminal of the third switch and a cathode coupled to a second terminal of the inductor;
a third diode having a cathode coupled to the first terminal of the third switch and an anode coupled to the second terminal of the inductor; and
a fourth diode having a cathode coupled to the third power source and an anode coupled to the second terminal of the third switch.

2. The plasma display device of claim 1, wherein the driving circuit turns on the third switch in the sustain period and uses a resonance of the inductor and the at least one of the first electrodes through a current path in an order of the third power source, the first diode, the third switch, the second diode, the inductor, and the first electrode to increase a voltage at the first electrode to be the first voltage.

3. The plasma display device of claim 1, wherein the driving circuit turns on the third switch in the sustain period and uses a resonance of the inductor and the first electrode through a current path in an order of the at least one of the first electrodes, the inductor, the third diode, the third switch, the fourth diode, and the third power source to decrease a voltage at the first electrode to be the second voltage.

4. The plasma display device of claim 1, wherein the driving circuit further comprises:
a fifth diode having an anode coupled to the first terminal of the third switch and a cathode coupled to the first power source; and
a sixth diode having a cathode coupled to the second terminal of the third switch and an anode coupled to the second power source.

5. The plasma display device of claim 1, wherein the third power source comprises a capacitor.

6. The plasma display device of claim 1, wherein the third power source supplies a voltage at a voltage level between the first voltage and the second voltage.

7. The plasma display device of claim 1, wherein the second voltage is at a ground voltage level.

8. The plasma display device of claim 1, wherein the third switch is a transistor.

9. The plasma display device of claim 1, wherein the third switch is an n-type transistor.

10. A method for driving a plasma display device for alternately applying a first voltage and a second voltage to a panel capacitor formed between a first electrode and a second electrode through a driving circuit including a switch and an inductor forming a resonance circuit, the method comprising:
generating a first resonance between the panel capacitor and the inductor through a first path formed through the switch, and charging a voltage at a first electrode of the panel capacitor to be the first voltage;
maintaining the voltage at the first electrode of the panel capacitor to be the first voltage;
generating a second resonance between the panel capacitor and the inductor through a second path formed through the switch, and discharging the voltage at the first electrode of the panel capacitor to be the second voltage, the second path being different from the first path; and
maintaining the voltage at the first electrode of the panel capacitor to be the second voltage.

11. The method of claim 10, wherein the driving circuit further comprises:
a first diode coupled between a power source for supplying a resonance voltage and the switch, the first diode being for forming a current direction from the power source to the switch; and
a second diode coupled between the switch and the inductor, the second diode being for forming a current direction from the switch to the inductor.

12. The method of claim 11, wherein the first path is formed in an order of the power source, the first diode, the switch, the second diode, and the inductor.

13. The method of claim 10, wherein the driving circuit further comprises:
a first diode coupled between the inductor and the switch, the first diode being for forming a current direction from the inductor to the switch; and
a second diode coupled between the switch and a power source for supplying a resonance voltage, the second diode being for forming a current direction from the switch to the power source.

14. The method of claim 13, wherein the second path is formed in an order of the inductor, the first diode, the switch, and the second diode.

15. The method of claim 10, wherein the driving circuit further comprises:
a first diode coupled between a power source for supplying a resonance voltage and the switch, the first diode being for forming a current direction from the power source to the switch;
a second diode coupled between the switch and the inductor, the second diode being for forming a current direction from the switch to the inductor;
a third diode coupled between the inductor and the switch, the third diode being for forming a current direction from the inductor to the switch; and
a fourth diode coupled between the switch and the power source, the fourth diode being for forming a current direction from the switch to the power source.

16. The method of claim 15, wherein the second path is formed in an order of the inductor, the third diode, the switch, and the fourth diode.

17. The method of claim 15, wherein the first path is formed in an order of the power source, the first diode, the switch, the second diode, and the inductor.

18. The method of claim 15, wherein the first path is formed in an order of the power source, the first diode, the switch, the second diode, and the inductor and wherein the second path is formed in an order of the inductor, the third diode, the switch, and the fourth diode.

19. The method of claim 18, wherein the power source supplies a third voltage at a voltage level between the first voltage and the second voltage.

20. The method of claim 19, wherein the third voltage is at a half of a voltage level of the first voltage.
